(19) United States
(12) Patent Application Publication
(10) Pub. No.: US 2025/0069539 A1
(43) Pub. Date: Feb. 27, 2025

(54) POWER OPTIMIZED MULTI-REGIONAL UPDATE DISPLAY

(71) Applicant: Intel Corporation, Santa Clara, CA (US)

(72) Inventors: Perazhi Sameer Kalathil, Folsom, CA (US); Vishal Ravindra Sinha, Portland, OR (US); Krishna Kishore Nidamanuri, Bangalore (IN); Mallari C. Hanchate, Bangalore (IN); Vivek Paranjape, Portland, OR (US); Kunjal S. Parikh, Fremont, CA (US); Roland P. Wooster, Folsom, CA (US)

(73) Assignee: Intel Corporation, Santa Clara, CA (US)

(21) Appl. No.: 18/738,798

(22) Filed: Jun. 10, 2024

(30) Foreign Application Priority Data
Aug. 21, 2023 (IN) 202341055980

(51) Int. Cl. G09G 3/20

(52) U.S. Cl. CPC G09G 3/2092; G09G 2330/021; G09G 2340/0435

(57) ABSTRACT

In one embodiment, a display panel may have multiple regions that are controlled by independent driver circuitries to allow for independent refreshing of different regions. Circuitry, e.g., in a graphics source or in the display, can determine, based on a partial frame update, which panel regions to refresh and refresh those regions, e.g., while not refreshing other regions of the panel.

### CROSS-REFERENCE TO RELATED APPLICATION

This application claims the benefit of and priority to Indian Application No. 202341055980, filed Aug. 21, 2023, and entitled, “POWER OPTIMIZED MULTI-REGIONAL UPDATE DISPLAY.” The disclosure of the prior application is considered part of and hereby incorporated by reference in its entirety in the disclosure of this application.

### BACKGROUND

Various regions of a display output can update at different rates, e.g., with one region updating at a faster rate than another region. However, current display technologies are not able to provide regional updates to allow for lower display power consumption.

### BRIEF DESCRIPTION OF THE DRAWINGS

FIG. 1 illustrates an example display with portions updating at different rates.

FIG. 2 illustrates an example computing system that may be implemented with current display technologies.

FIG. 3 illustrates an example system that can implement aspects of the present disclosure.

FIGS. 4A-4C illustrate an example panel with 24 (6×4) regions implementing aspects of the present disclosure.

FIGS. 5A-5B illustrate example flow diagrams of example processes implementing aspects of the present disclosure.

FIGS. 6A-6B illustrate examples of a source sending subsets of new display information to a panel in accordance with embodiments herein.

FIG. 7 illustrates an example computing device in which aspects of the present disclosure may be incorporated.

FIG. 8 illustrates an example block diagram of a computing device in which aspects of the present disclosure may be incorporated.

FIG. 9 is a block diagram of computing device components which may be included in a mobile computing device incorporating aspects of the present disclosure.

FIG. 10 is a block diagram of an example processor unit that can execute instructions.

### DETAILED DESCRIPTION

In the following description, specific details are set forth, but aspects of the technologies described herein may be practiced without these specific details. Well-known circuits, structures, and techniques have not been shown in detail to avoid obscuring an understanding of this description. “An embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact. Terms modified by the word “substantially” include arrangements, orientations, spacings, or positions that vary slightly from the meaning of the unmodified term. For example, description of a lid of a mobile computing device that can rotate to substantially 360 degrees with respect to a base of the mobile computing includes lids that can rotate to within several degrees of 360 degrees with respect to a device base.

The description may use the phrases “in an embodiment,” “in embodiments,” “in some embodiments,” and/or “in various embodiments,” each of which may refer to one or more of the same or different embodiments. Furthermore, the terms “comprising,” “including,” “having,” and the like, as used with respect to aspects of the present disclosure, are synonymous.

Reference is now made to the drawings, which are not necessarily drawn to scale, wherein similar or same numbers may be used to designate same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims. While aspects of the present disclosure may be used in any suitable type of computing device, the examples below describe example mobile computing devices/environments in which aspects of the present disclosure can be implemented.

### Power Optimized Multi-Regional Update Display

Display sources, e.g., graphics processing units (GPUs) or similar, of a computer device provide an output to a connected display panel, and the output to be displayed can have various regions that update at different rates. For instance, one portion of the output to be displayed on the panel may be a video application with a region that is updating at 24, 30, or 60 frames per second (FPS), while another region of the output to be displayed may be updating at a much slower rate (e.g., an application that is not in focus or use, an area of the video application that is not changing, a dock or taskbar for the operating system, etc.).

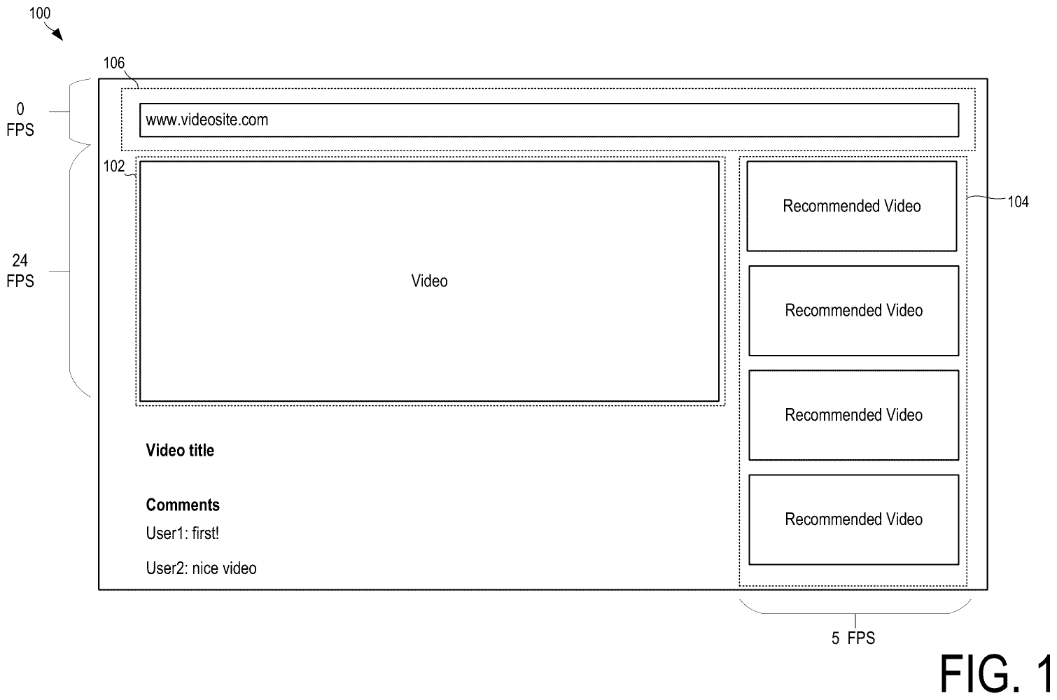

FIG. 1 illustrates an example display 100 with portions updating at different rates. In the example shown, the region 102 of the display 100 with a video being displayed may be getting updated frames at 24, 48, or 60 FPS (e.g., with 3:2 pulldown) whereas the region 104 is being updated at 5 FPS and the region 106 is not being updated (0 FPS). Current display technology standards can allow for the source to send to the display (e.g., to the timing controller (TCON) of the display) only those regions of a next frame that are updated from the prior frame. However, the panel of the display will still be entirely refreshed for the new frame to be displayed. That is, the entire display panel may be refreshed for each new frame received for the video region 102, even though the region 106 is not currently being updated.

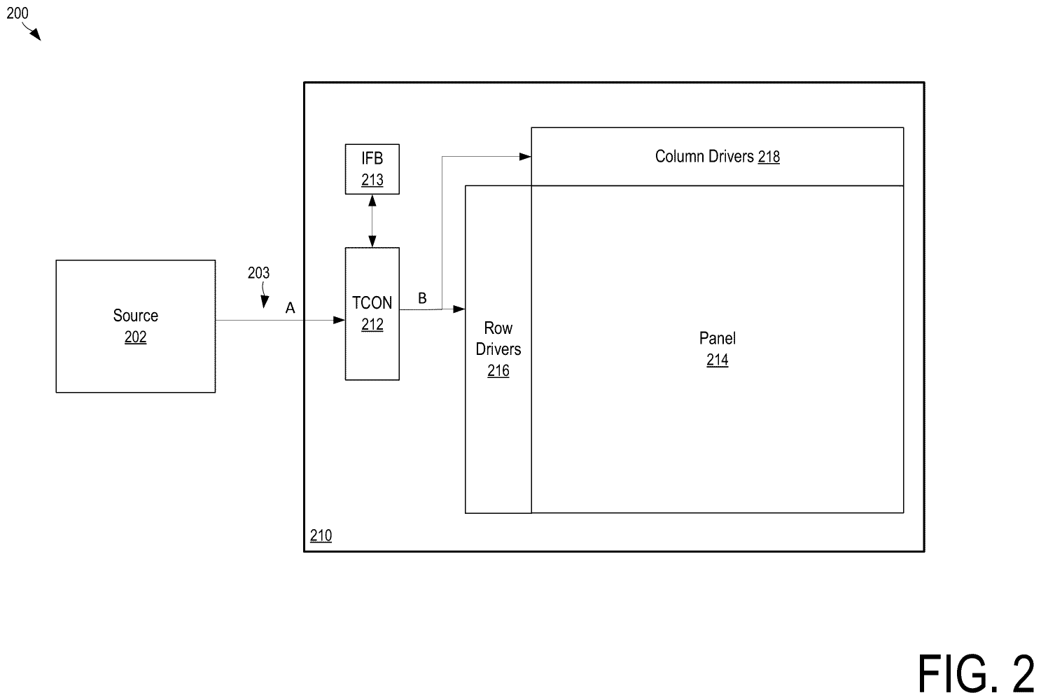

FIG. 2 illustrates an example computing system 200 that may be implemented with current display technologies. The computing system 200 includes a graphics source 202, which may be implemented as hardware, software, firmware, or a combination thereof. For example, the source 202 may include a GPU and/or a graphics driver. The computing system 200 further includes a display 210 with a TCON 212 that controls updates to a panel 214 via row drivers 216 and column drivers 218. The display 210 also includes an internal frame buffer (IFB) 213 for storing frame updates received from the source 202.

In current systems, such as the system 200, the source 202 can send to the TCON 212 a subset of frames (e.g., only those for one or more regions of the panel 214 being updated) (“A” in the example shown). In many instance, the link 203 between the source 202 and the TCON 212 may be unidirectional, with frame data being sent to the TCON 212 but no information about the panel being sent to the source 202. A typical Panel Self Refresh 2 (PSR2) panel may update its internal frame buffer with the new frame information, but the TCON 212 may continuously scan out to drive the row and column drivers 216, 218 (“B” in the example shown). The scanning may be repeated for the whole screen at a source-determined refresh rate (RR), or may be based on an internal minimum refresh rate of the panel 214. In any case, all areas of the panel 214 will be refreshed at a certain rate (e.g., 24, 48, or 60 Hz), even if only a portion (e.g., the region 102 of FIG. 1) requires a refresh and/or other portions are not being refreshed at the same rate (e.g., regions 104, 106 of FIG. 1). This is because existing display technologies support raster scan outs of all the scanlines at every display refresh cycle. The display refresh rate can be lowered, but if any scan lines need an update, then all the scanlines must be scanned out. Currently, there are no display technologies that allow for scanning different regions of the display at different refresh rates. Further, currently, there is no regional dynamic refresh capability available.

Aspects of the present disclosure provide techniques for allowing regional display panel updates. For example, aspects of the present disclosure bring source regional FPS awareness to the TCON and panel drivers of a display. A source may indicate regional updates as and when they happen. Existing standard techniques may be leveraged to do this (e.g., Video Electronics Standards Association (VESA) embedded DisplayPort uses Panel Self Refresh2 (PSR2) Selective Update mechanism for the same). The display, after receiving the regional update information from the source, may keep track of the regional updates and update row/column drivers of the display panel at the required granularity.

Embodiments herein can provide one or more advantages, e.g., allowing for reductions power consumption for the panel. For instance, in a personal computing environment, most often, only certain areas of a display may change continuously. Consider, for example, a word processing scenario where a user is typing and the whole screen other than the single line is static. In addition, the regional display refresh can also improve the latency of display updates for such instances (e.g., typing in a document) where only a small portion of the display is changing. The latency improvement can be in range of couple of scanline time to approximately a frame time depending on the location of update on the display.

Embodiments herein may be implemented either on the source or the panel side, and with either panel self refresh (PSR) or non-PSR display panel technologies. Further, embodiments herein may be implemented with any suitable number of panel regions, including an array of display panel regions in rows (e.g., N panel regions arranged in rows) or columns (e.g., M panel regions arranged in columns), or a matrix of panel regions (e.g., with N×M panel regions). Further, embodiments herein can be implemented via use of eDP auxilliary channels and known software stacks.

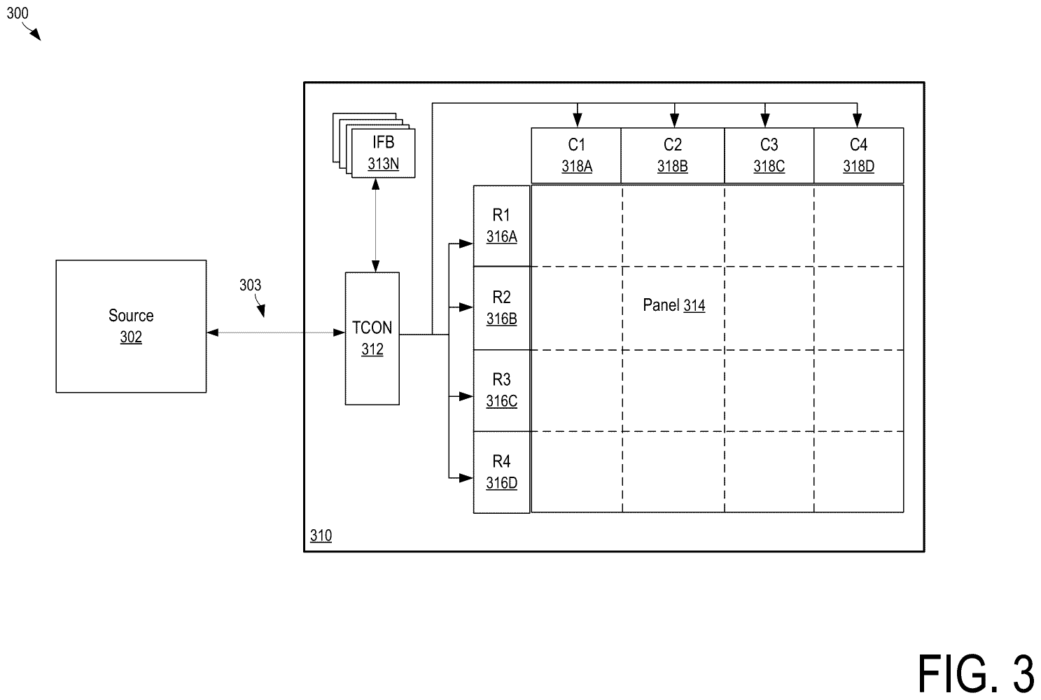

FIG. 3 illustrates an example computing system 300 that can implement aspects of the present disclosure. The computing system 300 includes a graphics source 302, which may be implemented as hardware, software, firmware, or a combination thereof. For example, the source 302 may include a GPU and/or a graphics driver. The computing system 300 further includes a display 310 with a TCON 312 that controls updates to various regions a panel 314 via sets of row drivers 316A-D and column drivers 318A-D. Although a certain number of regions are shown in the example system 300, embodiments may implement a panel with any suitable number of regions, in rows only, columns only, or both (e.g., as shown). The driver circuitries 316, 318 provide for independent control and refresh of the various regions of the panel 314. For instance, in some embodiments, each of the regions of the panel 314 may have a corresponding driver circuitry (e.g., a particular combination of a row driver and a column driver) that independently controls refreshing of the region.

The display 310 also includes a number N of internal frame buffers (IFBs) 313A-N for storing frame updates received from the source 302. In some embodiments, each region of the panel may have an associated buffer 313, e.g., a unique buffer associated therewith (1:1 buffer-to-region ratio), while in other embodiments, there may be other ratios (e.g., X buffers for N display panel regions, where X may be less than N). The buffer-to-region mapping may be static, or the buffers 313 may be assigned to the panel regions in a dynamic manner (e.g., as needed).

In some embodiments, the TCON 312 may implement the aspects of the present disclosure while the source 302 is unaware of the various display panel regions. The TCON 312 may provide regional updates based on full frame updates from the source 302, or based on partial frame updates from the source 302. In either case, the TCON 312 (or other circuitry of the display 310) may determine which regions of the panel 314 need updating from a previous frame, and update only those regions that need refreshed based on the new frame information from the source 302.

In some embodiments, however, panel information (e.g., the number of independently-driven regions in the display, refresh rates for each region, or buffers associated with each region) can be exposed/sent to the source 302 (over the link 303) and the source may generate frame updates for different regions as needed. For example, in certain embodiments, at bootup, a display 310 may indicate to the source 302 that it includes a number (N) or array (N×M) of panel regions. The display 310 may also indicate a particular refresh rate (RR) range supported by each of the separate panel regions. In some embodiments, the source 302 can determine which of the panel regions are to be updated based on usage or display frame updates that are to be sent to the panel. For example, the source may determine that only a certain small portion of a word processing application window is being updated and may send display updates accordingly. As another example, the source may determine that different regions of an application are being updated at different rates, e.g., as shown in FIG. 1.

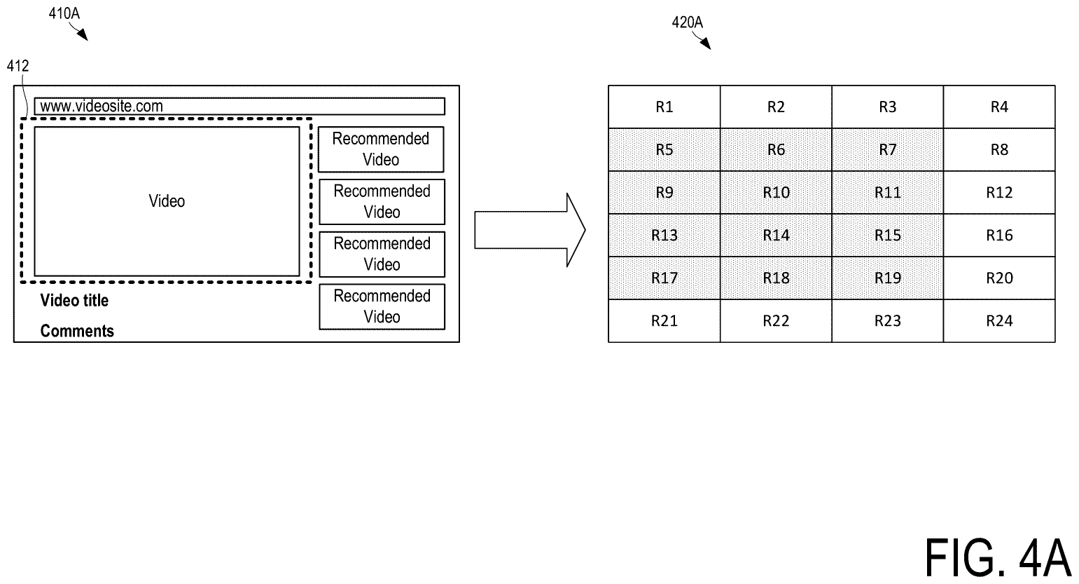

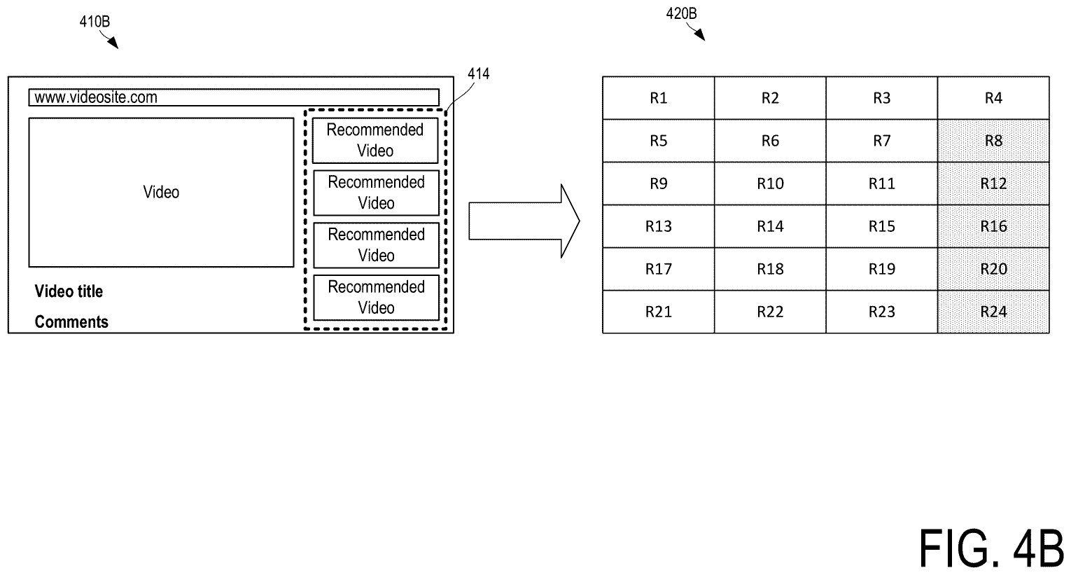

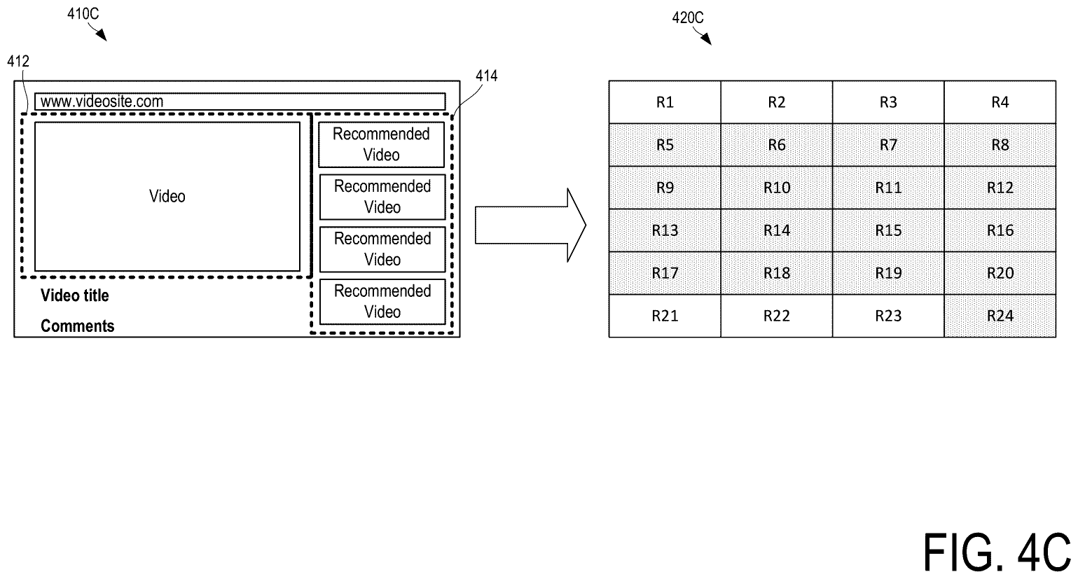

FIGS. 4A-4C illustrate an example panel 420 with 24 (6×4) regions (labeled R1-RN) implementing aspects of the present disclosure. The panel 420 may be part of a larger display apparatus, which may be implemented in a similar manner to the display 310 of FIG. 3 (with the panel 420 being implemented similar to the panel 314). That is, the panel 420 may have certain circuitries coupled thereto, e.g., TCON (e.g., 312), one or more frame buffers (e.g., 313), and drivers (e.g., 316) corresponding to the 24 regions of the panel, as described above with respect to FIG. 3. In the examples shown, the shaded regions represent regions of the panel 420 currently being refreshed based on a new frame 410A, 410B, or 410C, while the unshaded regions represent regions of the panel 420 not currently being refreshed based on the new frame 410A, 410B, or 410C. The unshaded regions may be updated at a minimum update rate, e.g., as required by the display (MinRegionUpdateHz[ ] in the pseudocode below).

FIG. 4A illustrates a first portion 412 of a frame 410A updating with high frequency similar to the scenario shown in FIG. 1 updates, i.e., the video portion 412 is updated while other regions of the frame are not updated. FIG. 4B illustrates another portion 414 of the frame 410B updating at a lower frequency than the portion 412. In some instances, e.g., the one shown in FIG. 4B, the portion 414 may update in a frame while other portions, e.g., 412, are not being updated (e.g., where the video portion has been paused and a user is scrolling on the side portion 414). In some instances, however, multiple portions of the frame may be updated simultaneously in the new frame. For example, FIG. 4C illustrates a combined update of the portions 412 and 414 in the frame 410C.

In some embodiments, a video source (e.g., 302) may send the entire frame 410 to the panel 420, even though only certain portions of the frame are being updated from a prior frame, and the panel 420 or circuitry coupled to the panel 420, e.g., a TCON (e.g., 312) may determine which regions of the panel to update based on the new frame information. In other embodiments, the source (e.g., 302) may only send a partial frame update, with information for the region(s) of the frame that are updated from the prior frame. For example, referring to FIG. 4A, the source can send only the updated video portion 412 of the frame 410A to the display, and the panel 420 or circuitry coupled to the panel may determine the subset of regions of the panel 420 to update based on the partial frame update. A TCON (e.g., 312) coupled to the panel 420 may accordingly drive the display panel drivers for the shaded regions only (i.e., cause them to perform an update) and not cause an update in the other unshaded regions.

In other embodiments, the source (e.g., 302) may be aware of the multiple regions of the panel 420 and may send frame information corresponding to each of the regions of the panel 420, or may send only partial frame updates for regions of the panel that are to be refreshed based on a new frame to be displayed (i.e., will send only new frame information for the regions corresponding to updated frame regions).

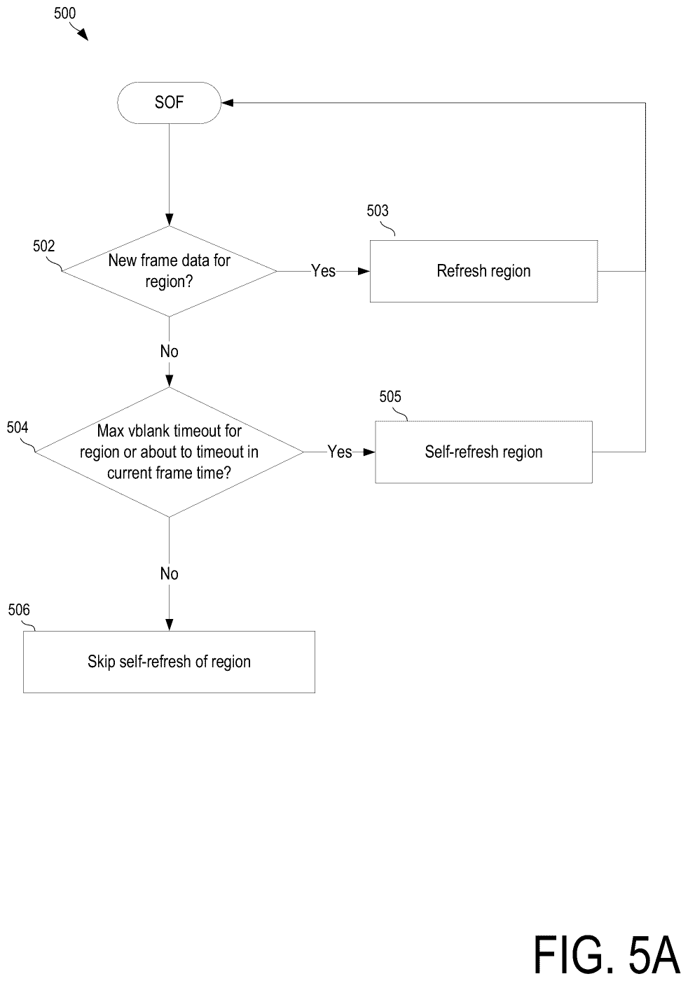

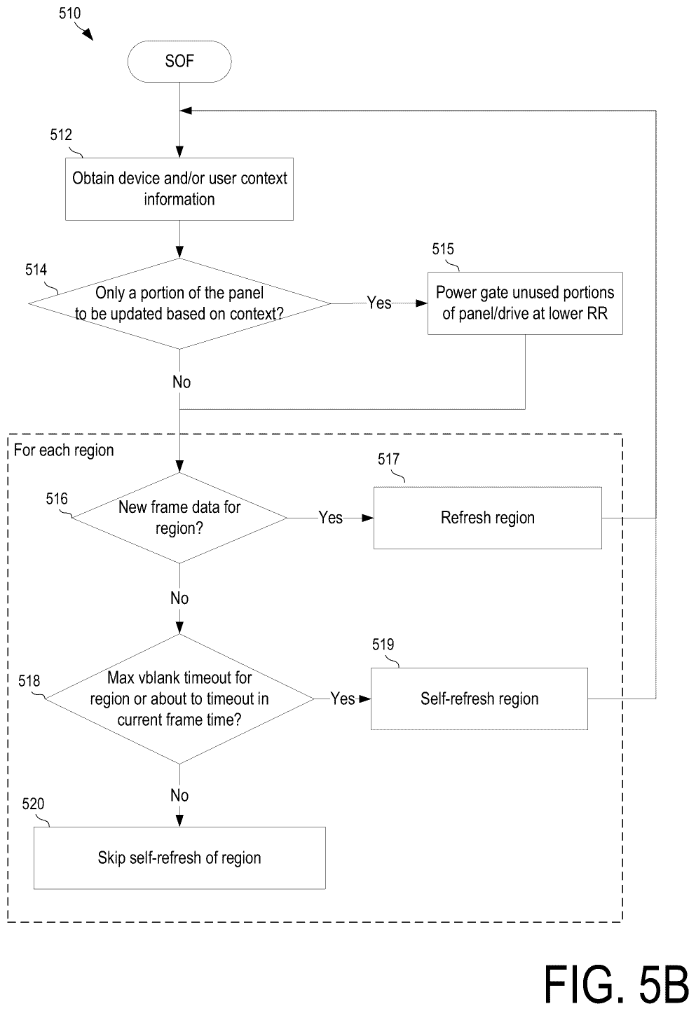

FIGS. 5A-5B illustrate example flow diagrams of example processes 500, 510 implementing aspects of the present disclosure. The example processes 500, 510 may allow for independent refreshing of different display panel regions (e.g., the regions of the panel 314 of FIG. 3). That is, the processes 500, 510 may be performed for each respective display panel region to control the refreshing of the region based on a partial frame update as described herein.

The example processes 500, 510 may include additional, fewer, or other operations shown. In addition, operations of the example processes 500, 510 may be performed separately as shown, or may be performed in other instances simultaneously or in parallel with one another. Certain of the operations may be performed or implemented by circuitry within a display, e.g., a TCON or other logic circuitry within the display coupled to the TCON, while certain operations may be performed or implemented by circuitry in a graphics source.

In some embodiments, certain operations shown may be encoded as instructions in one or more computer-readable media that can be read and executed by processing circuitry to perform the operations. For instance, the operations may be encoded as instructions in firmware, software, or a combination thereof, e.g., as firmware within a TCON or a graphics source device, or as graphics driver software. In some embodiments, aspects of the present disclosure may also be implemented within an application executing on a device, which can control or communicate with a graphics driver to implement one or more of the operations described herein. For example, in a source-aware embodiment, an application may obtain information about the panel regions, e.g., from the graphics driver, and can provide display updates based on that information. The application can ensure that the display updates are provided to the graphics driver in an efficient manner, such that only those regions that need updates are provided frame updates. In addition, in some embodiments, an application can provide feedback to the graphics driver related to the configuration of the regions needed for optimal operation, and the graphics driver can use this information to configure or update the panel regions accordingly.

Referring to FIG. 5A, at every start of frame (SOF), control circuitry will check at 502 if there is new frame data to be displayed. This can include a TCON determining whether new frame data (full or partial frame data) has been sent by a source, or a graphics driver at the source determining whether there is new frame data to be sent to the display/TCON. If there is new frame data for the panel regions, the display panel regions corresponding to the new/updated frame data will be refreshed at 503. For example, the TCON can drive a subset of driver circuit of the display backend that correspond to the regions to be refreshed, e.g., as shown in FIGS. 4A-4C and described above. In a source-aware example (where the source has knowledge of the different regions in the panel), the source can send only new frame data for the regions of the panel corresponding to areas in the frame that have new/updated data, and the TCON can refresh only those regions with new frame data from the source. The TCON can scan-out regions with new scanlines based on the display capabilities.

If there is no new frame data, at 504, it is determined, for each region, whether a max vblank timeout has occurred or is about to occur within the current frame time. If the max vblank is timing out or about to timeout, a full display scan out/self-refresh can be performed at 505. However, if the max vblank has not timed out or is not about to timeout for the region, the self-refresh can be skipped at 506. These operations can be done for each region of the panel, allowing for power savings.

Consider, for example, a scenario where the power required to refresh a panel region at 60 Hz is P₆₀ and the power to refresh at 1 Hz is P₁. When only one region out of N regions is refreshed at 60 Hz, effective power consumption for aspects herein will be (N−1)*P₁+P₆₀, whereas in current implementations the power consumption will be N*P₆₀. Where P₆₀=200 mW and P₁=100 mW and N=3, power consumption in current systems for one refresh will be 3*200=600 mW, while aspects of the present disclosure may provide power consumption for one refresh of 2*100+200=400 mW, resulting in a potential display power savings of 200 mW or ˜33%.

In some instances, aspects of the present disclosure can be extended to allow for power gating of portions of a display that do not require any information to be displayed or information to be updated. As one example, some devices may include foldable displays (e.g., in clamshell devices with a flexible organic light emitting diode (FOLED) display) where only certain portions of the display can or need to be updated. As an example, the device may include a sensor that can detect device context information indicating how certain components of the device are currently in use (e.g., whether a physical keyboard is on the bottom half of the display) or usage context information indicating how a user is interacting with the device (e.g., whether a user is looking at the bottom or top half of the screen, or looking at the device at all). The usage context information may be determined based on sensor devices, e.g., one or more cameras of the computer system. For instance, a device may use camera(s) to ascertain an area of the panel that may be readable by the user (e.g., within a range of approximately 1-4 degrees from where the user is currently looking) as opposed to just viewable (e.g., a range of approximately 180 degrees from where the user is currently looking), and may adjust frame refreshes accordingly. As an example, a foldable device may have a portion of the display at such an angle with respect to the user that the portion of the display is viewable but not readable by the user. A source may use this information to lower a refresh rate or otherwise adjust updated frame information being sent to the panel based on this usage context information. For instance, the source may send frame updates at a lower FPS for regions that are viewable but not readable by the user, despite frame updates otherwise occurring for those regions at a higher rate by the application/software executing on the device.

The context information may also include application context information indicating application functionality, e.g., whether portions of an application window being displayed are in use or refreshing at different rates than other portions or an indication of the content being displayed in a frame, or in various portions of a frame. For instance, referring to the examples in FIG. 1 and FIGS. 4A-4C above, application context information may include information indicating that certain portions (e.g., 102, 412) of a frame are displaying video, that certain portions (e.g., 106) are displaying static text, or that other portions (e.g., 104) contain updates ate a lower FPS. The application context information may also include application execution information related to whether an application window is currently “in focus” or in use. Aspects herein can use this context information to selectively update portions of the panel.

FIG. 5B illustrates a process 510 that is a modified version of the process 500 of FIG. 5A. The example process 510 takes into account potential context-based determinations with respect to panel region refreshing. For instance, at 512, device and/or usage context information is obtained, e.g., based on application data, sensor data, or a combination thereof. For example, sensor data may be analyzed to determine whether a user is not looking at the display at all, looking at one of multiple displays, or looking at only a portion of a display (e.g., a top or bottom portion of a foldable display). As another example, application data may be analyzed to determine if portion(s) of the display are being updated or not (e.g., whether a portion is displaying a taskbar that does not update regularly), whether portions need to be updated at all (e.g., a keyboard is displayed on a portion of a foldable or other type of display), etc.

At 514, it is determined based on the context information obtained at 512, whether only a subset of the display panel regions need to be updated in the current context. If so, then the portions of the panel that do not need to be updated may be power gated at 515. This can be done by setting a variable corresponding to the region (e.g., setting MinRegionUpdateHz[i] to zero, as in the later portion of the pseudocode below). Power gating can include holding the power constant to the drivers of those regions or driving the regions at lower refresh rates, which can provide additional power savings. If the entire display is to be updated (or checked for updates) based on the context information obtained at 512, then at 516, circuitry in the system determines if there is new frame data to be displayed on the panel, similar to the operation 502 described above with respect to FIG. 5A. If there is new frame data to be displayed, then the display panel portions corresponding to the new/updated frame data will be refreshed at 517, similar to the operation 503 above. If there is no new frame data, at 518, it is determined whether a max vblank timeout has occurred or is about to occur within the current frame time. If the max vblank is timing out or about to timeout, a full display scan out/self-refresh can be performed at 519. However, if the max vblank has not timed out or is not about to timeout, the self-refresh can be skipped at 520.

### Example Implementation #1

Consider in this example that a panel has N horizontal regions with a minimum required update refresh rate for each respective panel region, which is indicated by the variable MinRegionUpdateHz[i] below (where i=1 to N). If there is a frame change in a region that was previously static, that region must be updated in the next refresh cycle. This change per frame can be indicated by the variable IsRegionDirty[i] below. The TCON can update the variable IsRegionDirty[i] based on source updates. The variable IsRegionDirty[i] can be cleared once the TCON completes one cycle of the frame update and can be again set based on an updated region indication from the source for a subsequent frame. A display receiver can maintain the regional update required due to source changes in a variable SourceRegionUpdateHz[i]. The display will typically run at a base refresh rate (RR) in synchronization with the source. Usually, this will be a RR set in an operating system control panel, and region updates should not go beyond this base RR. Below is example pseudo-code for a multi-region update:

For all regions i=1 . . . . N:

```
BEGIN
  Update IsRegionDirty[i] as per PSR2 source update indication from
  source;
  If (IsRegionDirty[i])
    Update region, Ri
  Else
    Update Ri only at a rate of MinRegionUpdateHz[i]
  Recalculate average SourceRegionUpdateHz[i]
  IsRegionDirty[i] = 0
  If (MinRegionUpdateHz[i] == 0 and SourceRegionUpdateHz[i] == 0)
      Optionally power gate the region Ri, e.g., if region can be power
      gated based
      on context information as described above.
END
```

The concepts above can be extended to N×M regions as well. In addition, a source can implement these concepts as opposed to a TCON within a display, which can help to reduce TCON implementation complexity. In such cases, the source may be aware of the N or N×M regions in the display panel, and a minimum Hz per region. This information may be obtained from a display capabilities data source (e.g., via newer blocks in VESA EDID/DisplayID fields). The source can then handle the refresh logic as per the example pseudocode above and send updates to the TCON accordingly.

### Example Implementation #2

In some cases, the display may be capable of supporting regional updates where the native refresh rate is a multiple of the regional refresh rate (RR), allowing regional refreshes to be performed without any display artifacts. In this context, the native refresh rate refers to the maximum refresh rate supported by the display panel, and the regional refresh rate refers to the minimum refresh rate supported by the panel regions. This requirement may be necessary to maintain synchrony between the source and the display. The regional refresh rate can be determined based on the max vblank timeout, i.e., the time period after which the display needed to be refresh, e.g.:

$$The Native Refresh Rate ( RR ) = n \times Regional RR , where n = 1 , 2 , 3 , 4 , etc .$$

For example, where regional minimum refresh rates are 20 Hz and n=3, a native RR is 60 Hz, and where regional minimum refresh rates are 10 Hz and n=6, a native RR is 60 Hz. In other embodiments, regional refresh rates may be other rates, e.g., 12, 15, 20, or 30 Hz.

The source can send the TCON only the scanlines that have changed using the VESA Embedded DisplayPort (eDP) PSR2 Selective Update or similar standard/command. The source can also send the modified region area at the start of the frame (SOF) rather than at the scanline time so that the TCON can determine which regions of the display need to be updated and can scan out only those regions, e.g., as described above. Sending the data at the SOF may be required in some instances, as there might be scenarios where only a few scanlines in a display region are changed, in which case, the TCON can identify those regions and scan out those regions without adding latency. The SOF requirement might not be needed if the source is aware of the display regions and can align its frame updates based on the display regions (e.g., if one frame latency is not a concern).

### Example Implementation #3

This example implementation may be used for display panels that do not support panel self-refresh (PSR), which may be referred to as non-PSR panels. A non-PSR variable refresh rate (VRR) display where the native refresh rate is a multiple of the regional refresh rate (RR), allowing regional refreshes to be performed without any display artifacts. In this context, the native refresh rate refers to the maximum refresh rate supported by the display panel, and the regional refresh rate refers to the minimum refresh rate supported by the panel regions. This requirement is needed to maintain source and display in synchrony, as above. The regional refresh rate can be determined based on the max vblank timeout, i.e., the time period after which the display needed to be refresh as before, e.g.:

$$The Native Refresh Rate ( RR ) = n \times Regional RR , where n = 1 , 2 , 3 , 4 , etc .$$

For example, where regional minimum refresh rates are 20 Hz and n=3, a native RR is 60 Hz, and where regional minimum refresh rates are 10 Hz and n=6, a native RR is 60 Hz. In other embodiments, regional refresh rates may be other rates, e.g., 12, 15, 20, or 30 Hz.

In this example, a source can send the TCON only scanlines that have changed using a VESA Adaptive Sync Secondary Data Packet (AS SDP) indicating the coordinates of the changed region along with a RR at which the particular region needs to be refreshed. Additionally, the source can send the modified region area at the start of the frame, e.g., at Vsync time rather than at the scanline time so that the TCON can determine which regions of the display need to be refreshed and can scan out only those regions. The data may be sent at the SOF, as there may be scenarios where only couple scanlines in a display region are changed, in which case the TCON can identify those regions and scan out those regions without adding latency.

Further, in this example, the display might not have any frame buffers due to it being a non-PSR panel. Accordingly, the source can floor updates at a minimum refresh rate of the panel and make sure to update the complete frame when the max vblank time out occurs. As mentioned in the above example case, 20 Hz may be the minimum RR of the panel, and even though some of the regions might not have updates beyond 50 ms, the source may fetch the full frame and update the panel.

As previously discussed, a source (e.g., 302) may be aware of the multiple regions of a panel (e.g., 314) and may send updated frame information to the display with knowledge of the regions. For example, in some source-aware embodiments, the source may determine which regions of the panel are to be refreshed based on a new frame to be displayed, and can send only new frame information for the regions corresponding to the updated regions of the new frame. Further, in some source-aware embodiments utilizing VESA display stream compression (DSC), the source may adjust the slices used in the DSC algorithm to avoid refreshing multiple regions of a panel.

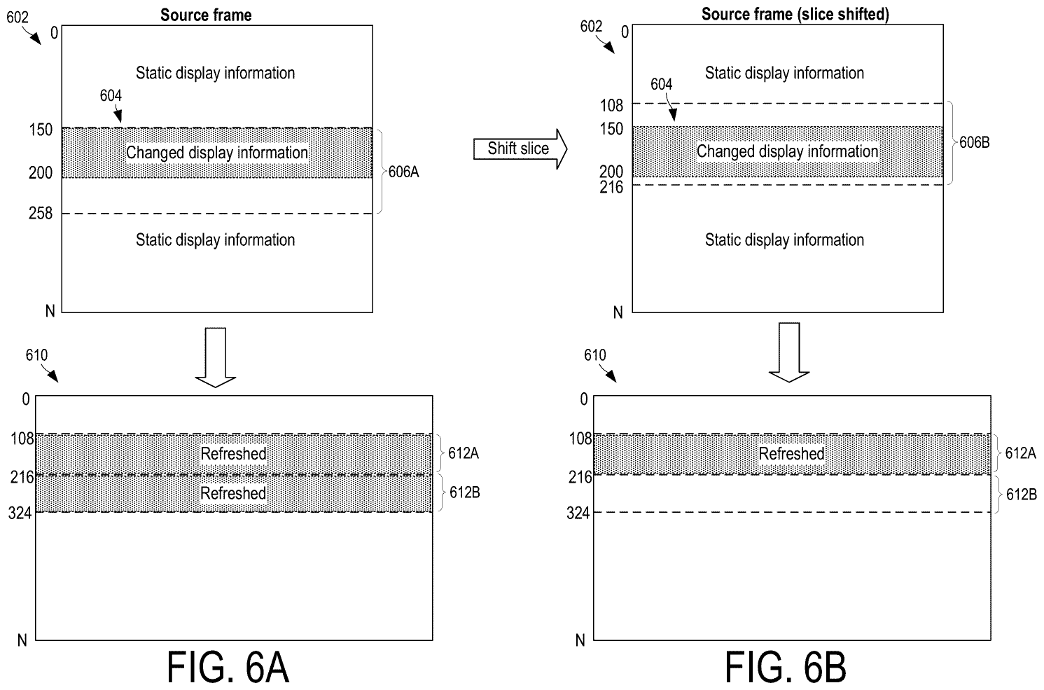

FIGS. 6A-6B illustrate examples of a source sending subsets of new display information to a panel in accordance with embodiments herein. In the example shown, a new source frame 602 is to be displayed on the panel 610, which includes a number of vertically-arranged regions spanning 108 lines each. The new source frame 602 has a portion 604 that contains new display information while other portions of the frame 602 are static (that is, do not include display information that has changed from the prior frame). The updated portion 604 spans from lines 150-200 of the frame. In each example, the source may be aware of the 108-line regions of the panel 610 and may send new display information to the panel 610 accordingly.

For instance, referring to the example shown in FIG. 6A, the source may know that the refresh for lines 150-200 will span only the two regions 612A, 612B of the panel 610 and send updated display information for those regions, e.g., display information for lines 108-324 only. This may be accomplished in DSC-enabled embodiments by sending information for a 108-line slice 606A that includes lines 150-258, since, in some cases, the minimum slice height for DSC may be 108 lines, and the slice may begin where the new display information begins (i.e., line 150). This will cause the panel 610 to refresh regions 612A, 612B as shown. The minimum slice height may be determined, in some instances, by dividing the vertical height of the display/frames (the resolution) by a number N lines, where N begins at 92 and 2 lines are added to N until the remainder becomes zero.

However, in the example shown in FIG. 6B, the source may further determine that the display information update of lines 150-200 falls entirely within the region 612A of the panel and not also 612B. Accordingly, the source may adjust the slice of information to prevent more panel regions from refreshing than are needed. For instance, in the example shown, the source may revise the slice location and send display information for the slice 606B, which spans lines 108-216, causing only the panel region 612A to refresh instead of both regions 612A, 612B as in the previous example. In the example shown, the display updates the slices to correspond to the height of the panel regions, however, the slice height may be updated in any other manner as well.

### Example Computing Systems

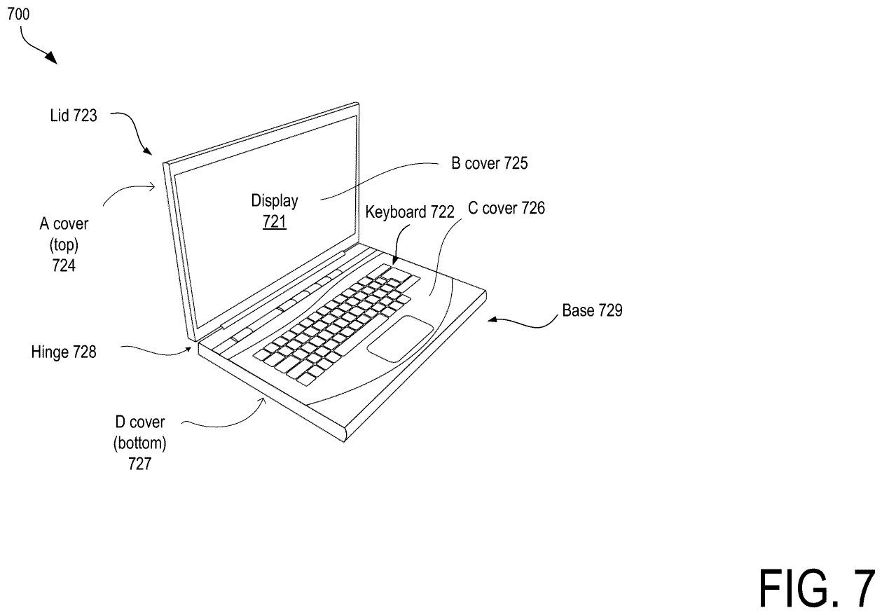

FIG. 7 illustrates an example computing device 700 in which aspects of the present disclosure may be incorporated. The computing device 700 can be a laptop (as shown) or another type of mobile computing device with a similar form factor, such as a foldable tablet or smartphone. In some instances, aspects of present disclosure may be incorporated into a free-standing display monitor with a user-facing camera, which may be connected to a computing device that controls the display and camera.

The computing device 700 includes a housing, which includes a lid 723 with an A cover 724 that is a “world-facing” surface of the lid 723 when the computing device 700 is in a closed configuration and a B cover 725 that comprises a user-facing display 721 when the lid 723 is open (e.g., as shown). The computing device 700 also includes a base 729 with a C cover 726 that includes a keyboard 722 that is upward facing when the device 700 is an open configuration (e.g., as shown) and a D cover 727 that forms the bottom of the base 729. In some embodiments, the base 729 includes the primary computing resources (e.g., host processor unit(s), graphics processing unit (GPU)) of the device 700, along with a battery, memory, and storage, and communicates with the lid 723 via wires that pass through a hinge 728 that connects the base 729 with the lid 723. In some embodiments, the computing device 700 can be a dual display device with a second display comprising a portion of the C cover 726. For example, in some embodiments, an “always-on” display (AOD) can occupy a region of the C cover below the keyboard that is visible when the lid 723 is closed. In other embodiments, a second display covers most of the surface of the C cover and a removable keyboard can be placed over the second display or the second display can present a virtual keyboard to allow for keyboard input.

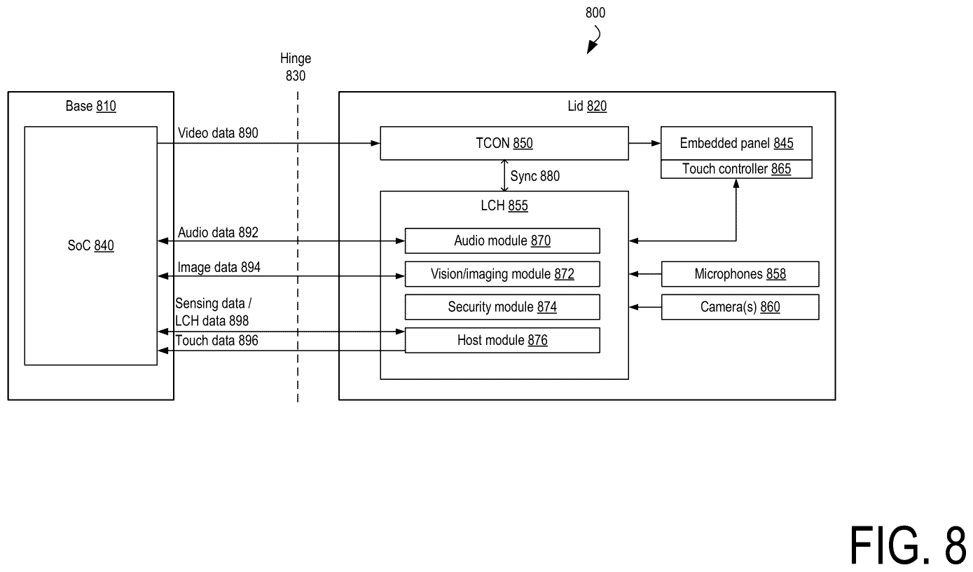

FIG. 8 illustrates an example block diagram of a computing device in which aspects of the present disclosure may be incorporated. The example mobile computing devices shown implement a lid controller hub (e.g., 855) with various circuitries that can enable a reduced number of wires across a hinge of the device, i.e., from the base 810 to the lid 820. However, other embodiments may not implement a lid controller hub as shown and described below (e.g., such functionality may be implemented within the SoC 840).

The computing device 800 comprises a base 810 connected to a lid 820 by a hinge 830. The mobile computing device (also referred to herein as “user device”) 800 can be a laptop or a mobile computing device with a similar form factor. The base 810 comprises a host system-on-a-chip (SoC) 840 that comprises one or more processor units integrated with one or more additional components, such as a memory controller, graphics processing unit (GPU), caches, an image processing module, and other components described herein. The base 810 can further comprise a physical keyboard, touchpad, battery, memory, storage, and external ports. The lid 820 comprises an embedded display panel 845, a timing controller (TCON) 850, a lid controller hub (LCH) 855, microphones 858, one or more cameras 860, and a touch controller 865. TCON 850 converts video data 890 received from the SoC 840 into signals that drive the display panel 845.

The display panel 845 can be any type of embedded display in which the display elements responsible for generating light or allowing the transmission of light are located in each pixel. Such displays may include TFT LCD (thin-film-transistor liquid crystal display), micro-LED (micro-light-emitting diode (LED)), OLED (organic LED), and QLED (quantum dot LED) displays. A touch controller 865 drives the touchscreen technology utilized in the display panel 845 and collects touch sensor data provided by the employed touchscreen technology. The display panel 845 can comprise a touchscreen comprising one or more dedicated layers for implementing touch capabilities or ‘in-cell’ or ‘on-cell’ touchscreen technologies that do not require dedicated touchscreen layers.

The microphones 858 can comprise microphones located in the bezel of the lid or in-display microphones located in the display area, the region of the panel that displays content. The one or more cameras 860 can similarly comprise cameras located in the bezel or in-display cameras located in the display area.

LCH 855 comprises an audio module 870, a vision/imaging module 872, a security module 874, and a host module 876. The audio module 870, the vision/imaging module 872 and the host module 876 interact with lid sensors process the sensor data generated by the sensors. The audio module 870 interacts with the microphones 858 and processes audio sensor data generated by the microphones 858, the vision/imaging module 872 interacts with the one or more cameras 860 and processes image sensor data generated by the one or more cameras 860, and the host module 876 interacts with the touch controller 865 and processes touch sensor data generated by the touch controller 865. A synchronization signal 880 is shared between the TCON 850 and the LCH 855. The synchronization signal 880 can be used to synchronize the sampling of touch sensor data and the delivery of touch sensor data to the SoC 840 with the refresh rate of the display panel 845 to allow for a smooth and responsive touch experience at the system level.

As used herein, the phrase “sensor data” can refer to sensor data generated or provided by sensor as well as sensor data that has undergone subsequent processing. For example, image sensor data can refer to sensor data received at a frame router in a vision/imaging module as well as processed sensor data output by a frame router processing stack in a vision/imaging module. The phrase “sensor data” can also refer to discrete sensor data (e.g., one or more images captured by a camera) or a stream of sensor data (e.g., a video stream generated by a camera, an audio stream generated by a microphone). The phrase “sensor data” can further refer to metadata generated from the sensor data, such as a gesture determined from touch sensor data or a head orientation or facial landmark information generated from image sensor data.

The audio module 870 processes audio sensor data generated by the microphones 858 and in some embodiments enables features such as Wake on Voice (causing the device 800 to exit from a low-power state when a voice is detected in audio sensor data), Speaker ID (causing the device 800 to exit from a low-power state when an authenticated user's voice is detected in audio sensor data), acoustic context awareness (e.g., filtering undesirable background noises), speech and voice pre-processing to condition audio sensor data for further processing by neural network accelerators, dynamic noise reduction, and audio-based adaptive thermal solutions.

The vision/imaging module 872 processes image sensor data generated by the one or more cameras 860 and in various embodiments can enable features such as Wake on Face (causing the device 800 to exit from a low-power state when a face is detected in image sensor data) and Face ID (causing the device 800 to exit from a low-power state when an authenticated user's face is detected in image sensor data). In some embodiments, the vision/imaging module 872 can enable one or more of the following features: head orientation detection, determining the location of facial landmarks (e.g., eyes, mouth, nose, eyebrows, check) in an image, and multi-face detection.

The host module 876 processes touch sensor data provided by the touch controller 865. The host module 876 is able to synchronize touch-related actions with the refresh rate of the embedded panel 845. This allows for the synchronization of touch and display activities at the system level, which provides for an improved touch experience for any application operating on the mobile computing device.

The hinge 830 can be any physical hinge that allows the base 810 and the lid 820 to be rotatably connected. The wires that pass across the hinge 830 comprise wires for passing video data 890 from the SoC 840 to the TCON 850, wires for passing audio data 892 between the SoC 840 and the audio module 870, wires for providing image data 894 from the vision/imaging module 872 to the SoC 840, wires for providing touch data 896 from the LCH 855 to the SoC 840, and wires for providing data 898 determined from image sensor data and other information generated by the LCH 855 from the host module 876 to the SoC 840. In some embodiments, data shown as being passed over different sets of wires between the SoC and LCH are communicated over the same set of wires. For example, in some embodiments, all of the different types of data shown can be sent over a single PCIe-based or USB-based data bus.

In some embodiments, the data 898 may be bidirectional and may include data from the SoC 840 comprising partial frame updates to be displayed on the panel 845 and may further include data from the host module 876 to the SoC 840 comprising information related to the panel 845 (e.g., a number of independently-driven panel regions the panel 845 has, as well as the refresh rates or other information for each respective region, to allow for the SoC 840 to be source-aware of the regions and transmit frame data for display on the panel 845 accordingly) or information about a usage context (e.g., based on data from the camera 860, whether a user is looking at certain portions of the panel 845 or even looking at the panel 845 at all).

In some embodiments, the lid 820 is removably attachable to the base 810. In some embodiments, the hinge can allow the base 810 and the lid 820 to rotate to substantially 360 degrees with respect to each other. In some embodiments, the hinge 830 carries fewer wires to communicatively couple the lid 820 to the base 810 relative to existing computing devices that do not have an LCH. This reduction in wires across the hinge 830 can result in lower device cost, not just due to the reduction in wires, but also due to being a simpler electromagnetic and radio frequency interface (EMI/RFI) solution.

The components illustrated in FIG. 8 as being located in the base of a mobile computing device can be located in a base housing and components illustrated in FIG. 8 as being located in the lid of a mobile computing device can be located in a lid housing.

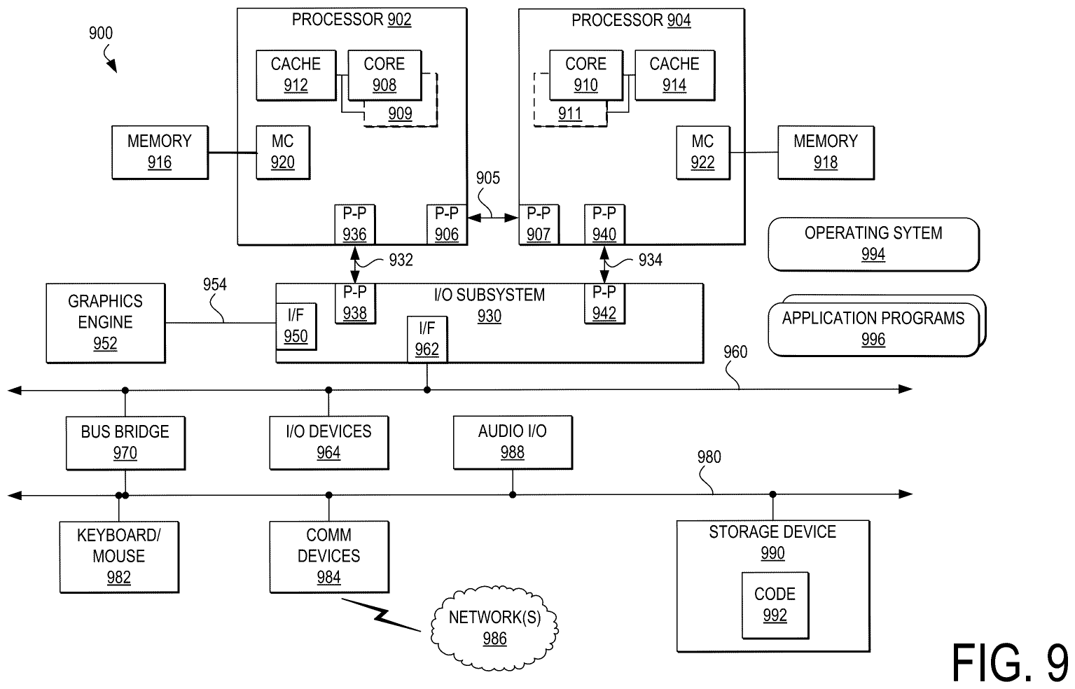

FIG. 9 is a block diagram of computing device components which may be included in a mobile computing device incorporating aspects of the present disclosure. In some embodiments, the components shown may be implemented within the SoC 840 of FIG. 8, for instance. Generally, components shown in FIG. 9 can communicate with other shown components, including those in a lid controller hub, although not all connections are shown, for ease of illustration. The components 900 comprise a multiprocessor system comprising a first processor 902 and a second processor 904 and is illustrated as comprising point-to-point (P-P) interconnects. For example, a point-to-point (P-P) interface 906 of the processor 902 is coupled to a point-to-point interface 907 of the processor 904 via a point-to-point interconnection 905. It is to be understood that any or all of the point-to-point interconnects illustrated in FIG. 9 can be alternatively implemented as a multi-drop bus, and that any or all buses illustrated in FIG. 9 could be replaced by point-to-point interconnects.

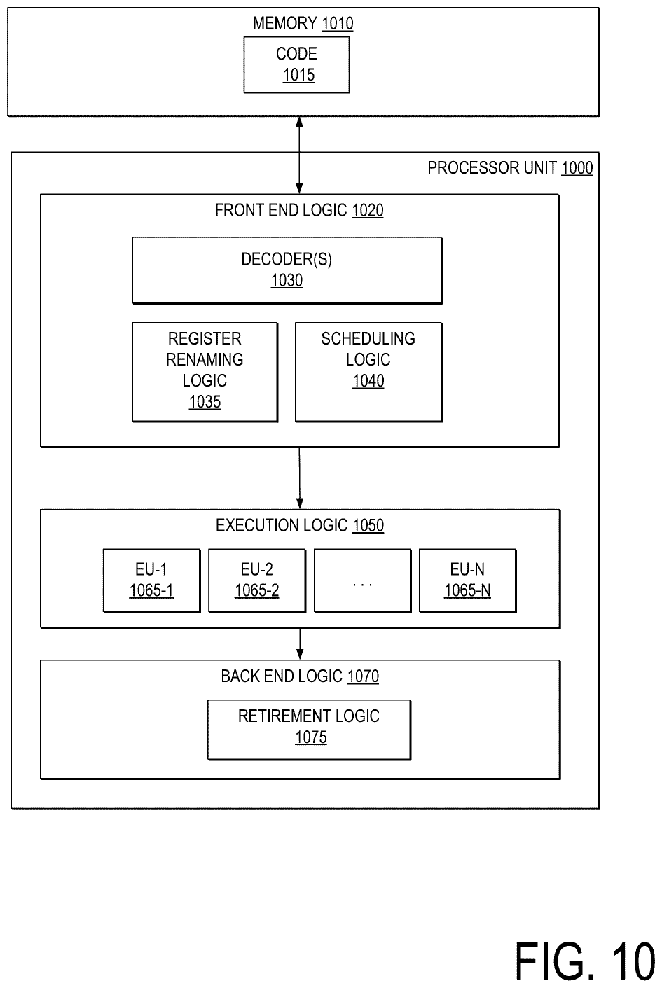

As shown in FIG. 9, the processors 902 and 904 are multicore processors. Processor 902 comprises processor cores 908 and 909, and processor 904 comprises processor cores 910 and 911. Processor cores 908-911 can execute computer-executable instructions in a manner similar to that discussed below in connection with FIG. 10, or in other manners.

Processors 902 and 904 further comprise at least one shared cache memory 912 and 914, respectively. The shared caches 912 and 914 can store data (e.g., instructions) utilized by one or more components of the processor, such as the processor cores 908-909 and 910-911. The shared caches 912 and 914 can be part of a memory hierarchy for the device. For example, the shared cache 912 can locally store data that is also stored in a memory 916 to allow for faster access to the data by components of the processor 902. In some embodiments, the shared caches 912 and 914 can comprise multiple cache layers, such as level 1 (L1), level 2 (L2), level 3 (L3), level 4 (L4), and/or other caches or cache layers, such as a last level cache (LLC).

Although two processors are shown, the device can comprise any number of processors or other compute resources, including those in a lid controller hub. Further, a processor can comprise any number of processor cores. A processor can take various forms such as a central processing unit, a controller, a graphics processor, an accelerator (such as a graphics accelerator, digital signal processor (DSP), or artificial intelligence (AI) accelerator)). A processor in a device can be the same as or different from other processors in the device. In some embodiments, the device can comprise one or more processors that are heterogeneous or asymmetric to a first processor, accelerator, field programmable gate array (FPGA), or any other processor. There can be a variety of differences between the processing elements in a system in terms of a spectrum of metrics of merit including architectural, microarchitectural, thermal, power consumption characteristics and the like. These differences can effectively manifest themselves as asymmetry and heterogeneity amongst the processors in a system. In some embodiments, the processors 902 and 904 reside in a multi-chip package. As used herein, the terms “processor unit” and “processing unit” can refer to any processor, processor core, component, module, engine, circuitry or any other processing element described herein. A processor unit or processing unit can be implemented in hardware, software, firmware, or any combination thereof capable of. A lid controller hub can comprise one or more processor units.

Processors 902 and 904 further comprise memory controller logic (MC) 920 and 922. As shown in FIG. 9, MCs 920 and 922 control memories 916 and 918 coupled to the processors 902 and 904, respectively. The memories 916 and 918 can comprise various types of memories, such as volatile memory (e.g., dynamic random-access memories (DRAM), static random-access memory (SRAM)) or non-volatile memory (e.g., flash memory, solid-state drives, chalcogenide-based phase-change non-volatile memories). While MCs 920 and 922 are illustrated as being integrated into the processors 902 and 904, in alternative embodiments, the MCs can be logic external to a processor, and can comprise one or more layers of a memory hierarchy.

Processors 902 and 904 are coupled to an Input/Output (I/O) subsystem 930 via P-P interconnections 932 and 934. The point-to-point interconnection 932 connects a point-to-point interface 936 of the processor 902 with a point-to-point interface 938 of the I/O subsystem 930, and the point-to-point interconnection 934 connects a point-to-point interface 940 of the processor 904 with a point-to-point interface 942 of the I/O subsystem 930. Input/Output subsystem 930 further includes an interface 950 to couple I/O subsystem 930 to a graphics module 952, which can be a high-performance graphics module. The I/O subsystem 930 and the graphics module 952 are coupled via a bus 954. Alternately, the bus 954 could be a point-to-point interconnection.

Input/Output subsystem 930 is further coupled to a first bus 960 via an interface 962. The first bus 960 can be a Peripheral Component Interconnect (PCI) bus, a PCI Express (PCIe) bus, another third generation I/O (input/output) interconnection bus or any other type of bus.

Various I/O devices 964 can be coupled to the first bus 960. A bus bridge 970 can couple the first bus 960 to a second bus 980. In some embodiments, the second bus 980 can be a low pin count (LPC) bus. Various devices can be coupled to the second bus 980 including, for example, a keyboard/mouse 982, audio I/O devices 988 and a storage device 990, such as a hard disk drive, solid-state drive or other storage device for storing computer-executable instructions (code) 992. The code 992 can comprise computer-executable instructions for performing technologies described herein. Additional components that can be coupled to the second bus 980 include communication device(s) or components 984, which can provide for communication between the device and one or more wired or wireless networks 986 (e.g. Wi-Fi, cellular or satellite networks) via one or more wired or wireless communication links (e.g., wire, cable, Ethernet connection, radio-frequency (RF) channel, infrared channel, Wi-Fi channel) using one or more communication standards (e.g., IEEE 802.11 standard and its supplements).

The device can comprise removable memory such as flash memory cards (e.g., SD (Secure Digital) cards), memory sticks, Subscriber Identity Module (SIM) cards). The memory in the computing device (including caches 912 and 914, memories 916 and 918 and storage device 990, and memories in the lid controller hub) can store data and/or computer-executable instructions for executing an operating system 994, or application programs 996. Example data includes web pages, text messages, images, sound files, video data, sensor data or any other data received from a lid controller hub, or other data sets to be sent to and/or received from one or more network servers or other devices by the device via one or more wired or wireless networks, or for use by the device. The device can also have access to external memory (not shown) such as external hard drives or cloud-based storage.

The operating system 994 can control the allocation and usage of the components illustrated in FIG. 9 and support one or more application programs 996. The application programs 996 can include common mobile computing device applications (e.g., email applications, calendars, contact managers, web browsers, messaging applications) as well as other computing applications.

The device can support various input devices, such as a touchscreen, microphones, cameras (monoscopic or stereoscopic), trackball, touchpad, trackpad, mouse, keyboard, proximity sensor, light sensor, pressure sensor, infrared sensor, electrocardiogram (ECG) sensor, PPG (photoplethysmogram) sensor, galvanic skin response sensor, and one or more output devices, such as one or more speakers or displays. Any of the input or output devices can be internal to, external to or removably attachable with the device. External input and output devices can communicate with the device via wired or wireless connections.

In addition, the computing device can provide one or more natural user interfaces (NUIs). For example, the operating system 994, applications 996, or a lid controller hub can comprise speech recognition as part of a voice user interface that allows a user to operate the device via voice commands. Further, the device can comprise input devices and components that allows a user to interact with the device via body, hand, or face gestures.

The device can further comprise one or more communication components 984. The components 984 can comprise wireless communication components coupled to one or more antennas to support communication between the device and external devices. Antennas can be located in a base, lid, or other portion of the device. The wireless communication components can support various wireless communication protocols and technologies such as Near Field Communication (NFC), IEEE 802.11 (Wi-Fi) variants, WiMax, Bluetooth, Zigbee, 4G Long Term Evolution (LTE), Code Division Multiplexing Access (CDMA), Universal Mobile Telecommunication System (UMTS) and Global System for Mobile Telecommunication (GSM). In addition, the wireless modems can support communication with one or more cellular networks for data and voice communications within a single cellular network, between cellular networks, or between the mobile computing device and a public switched telephone network (PSTN).

The device can further include at least one input/output port (which can be, for example, a USB, IEEE 1394 (FireWire), Ethernet and/or RS-232 port) comprising physical connectors; a power supply (such as a rechargeable battery); a satellite navigation system receiver, such as a GPS receiver; a gyroscope; an accelerometer; and a compass. A GPS receiver can be coupled to a GPS antenna. The device can further include one or more additional antennas coupled to one or more additional receivers, transmitters and/or transceivers to enable additional functions.

FIG. 9 illustrates one example computing device architecture. Computing devices based on alternative architectures can be used to implement technologies described herein. For example, instead of the processors 902 and 904, and the graphics module 952 being located on discrete integrated circuits, a computing device can comprise a SoC (system-on-a-chip) integrated circuit incorporating one or more of the components illustrated in FIG. 9. In one example, an SoC can comprise multiple processor cores, cache memory, a display driver, a GPU, multiple I/O controllers, an AI accelerator, an image processing unit driver, I/O controllers, an AI accelerator, an image processor unit. Further, a computing device can connect elements via bus or point-to-point configurations different from that shown in FIG. 9. Moreover, the illustrated components in FIG. 9 are not required or all-inclusive, as shown components can be removed and other components added in alternative embodiments.

FIG. 10 is a block diagram of an example processor unit 1000 to execute computer-executable instructions. The processor unit 1000 can be any type of processor or processor core, such as a microprocessor, an embedded processor, a digital signal processor (DSP), network processor, or accelerator. The processor unit 1000 can be a single-threaded core or a multithreaded core in that it may include more than one hardware thread context (or “logical processor”) per core.

FIG. 10 also illustrates a memory 1010 coupled to the processor 1000. The memory 1010 can be any memory described herein or any other memory known to those of skill in the art. The memory 1010 can store computer-executable instructions 1015 (code) executable by the processor unit 1000.

The processor core comprises front-end logic 1020 that receives instructions from the memory 1010. An instruction can be processed by one or more decoders 1030. The decoder 1030 can generate as its output a micro operation such as a fixed width micro operation in a predefined format, or generate other instructions, microinstructions, or control signals, which reflect the original code instruction. The front-end logic 1020 further comprises register renaming logic 1035 and scheduling logic 1040, which generally allocate resources and queues operations corresponding to converting an instruction for execution.

The processor unit 1000 further comprises execution logic 1050, which comprises one or more execution units (EUs) 1065-1 through 1065-N. Some processor core embodiments can include a number of execution units dedicated to specific functions or sets of functions. Other embodiments can include only one execution unit or one execution unit that can perform a particular function. The execution logic 1050 performs the operations specified by code instructions. After completion of execution of the operations specified by the code instructions, back end logic 1070 retires instructions using retirement logic 1075. In some embodiments, the processor unit 1000 allows out of order execution but requires in-order retirement of instructions. Retirement logic 1075 can take a variety of forms as known to those of skill in the art (e.g., re-order buffers or the like).

The processor unit 1000 is transformed during execution of instructions, at least in terms of the output generated by the decoder 1030, hardware registers and tables utilized by the register renaming logic 1035, and any registers (not shown) modified by the execution logic 1050. Although not illustrated in FIG. 10, a processor can include other elements on an integrated chip with the processor unit 1000. For example, a processor may include additional elements such as memory control logic, one or more graphics modules, I/O control logic and/or one or more caches.

As used in any embodiment herein, the term “module” refers to logic that may be implemented in a hardware component or device, software or firmware running on a processor, or a combination thereof, to perform one or more operations consistent with the present disclosure. Software may be embodied as a software package, code, instructions, instruction sets and/or data recorded on non-transitory computer-readable storage mediums. Firmware may be embodied as code, instructions or instruction sets and/or data that are hard-coded (e.g., nonvolatile) in memory devices. As used in any embodiment herein, the term “circuitry” can comprise, for example, singly or in any combination, hardwired circuitry, programmable circuitry such as computer processors comprising one or more individual instruction processing cores, state machine circuitry, and/or firmware that stores instructions executed by programmable circuitry. Modules described herein may, collectively or individually, be embodied as circuitry that forms a part of one or more devices. Thus, any of the modules can be implemented as circuitry, such as continuous itemset generation circuitry, entropy-based discretization circuitry, etc. A computer device referred to as being programmed to perform a method can be programmed to perform the method via software, hardware, firmware or combinations thereof.

In some embodiments, a lid controller hub is a packaged integrated circuit comprising components (modules, ports, controllers, driver, timings, blocks, accelerators, processors, etc.) described herein as being a part of the lid controller hub. Lid controller hub components can be implemented as dedicated circuitry, programmable circuitry that operates firmware or software, or a combination thereof. Thus, modules can be alternately referred to as “circuitry” (e.g., “image preprocessing circuitry”). Modules can also be alternately referred to as “engines” (e.g., “security engine”, “host engine”, “vision/imaging engine,” “audio engine”) and an “engine” can be implemented as a combination of hardware, software, firmware or a combination thereof. Further, lid controller hub modules (e.g., audio module, vision/imaging module) can be combined with other modules and individual modules can be split into separate modules.

The use of reference numbers in the claims and the specification is meant as in aid in understanding the claims and the specification and is not meant to be limiting.

Any of the disclosed methods can be implemented as computer-executable instructions or a computer program product. Such instructions can cause a computer or one or more processors capable of executing computer-executable instructions to perform any of the disclosed methods. Generally, as used herein, the term “computer” refers to any computing device or system described or mentioned herein, or any other computing device. Thus, the term “computer-executable instruction” refers to instructions that can be executed by any computing device described or mentioned herein, or any other computing device.

The computer-executable instructions or computer program products as well as any data created and used during implementation of the disclosed technologies can be stored on one or more tangible or non-transitory computer-readable storage media, such as optical media discs (e.g., DVDs, CDs), volatile memory components (e.g., DRAM, SRAM), or non-volatile memory components (e.g., flash memory, solid state drives, chalcogenide-based phase-change non-volatile memories). Computer-readable storage media can be contained in computer-readable storage devices such as solid-state drives, USB flash drives, and memory modules. Alternatively, the computer-executable instructions may be performed by specific hardware components that contain hardwired logic for performing all or a portion of disclosed methods, or by any combination of computer-readable storage media and hardware components.

The computer-executable instructions can be part of, for example, a dedicated software application or a software application that is accessed via a web browser or other software application (such as a remote computing application). Such software can be read and executed by, for example, a single computing device or in a network environment using one or more networked computers. Further, it is to be understood that the disclosed technology is not limited to any specific computer language or program. For instance, the disclosed technologies can be implemented by software written in C++, Java, Perl, Python, JavaScript, Adobe Flash, or any other suitable programming language. Likewise, the disclosed technologies are not limited to any particular computer or type of hardware.

Furthermore, any of the software-based embodiments (comprising, for example, computer-executable instructions for causing a computer to perform any of the disclosed methods) can be uploaded, downloaded or remotely accessed through a suitable communication means. Such suitable communication means include, for example, the Internet, the World Wide Web, an intranet, cable (including fiber optic cable), magnetic communications, electromagnetic communications (including RF, microwave, and infrared communications), electronic communications, or other such communication means.

As used in this application and in the claims, a list of items joined by the term “and/or” can mean any combination of the listed items. For example, the phrase “A, B and/or C” can mean A; B; C; A and B; A and C; B and C; or A, B, and C. Further, as used in this application and in the claims, a list of items joined by the term “at least one of” can mean any combination of the listed terms. For example, the phrase “at least one of A, B, or C” can mean A; B; C; A and B; A and C; B and C; or A, B, and C. Moreover, as used in this application and in the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Certain non-limiting examples of the presently described techniques are provided below. Each of the following non-limiting examples may stand on its own or may be combined in any permutation or combination with any one or more of the other examples provided below or throughout the present disclosure.
Example P1 is an apparatus comprising: circuitry to couple the apparatus to a plurality of display panel drivers, each driver to drive a respective portion of the panel; and control circuitry to cause a subset of the display panel drivers to be updated based on a partial frame update, the subset of display panel drivers corresponding to portions of the display to be updated by the partial frame update.
Example P2 includes the subject matter of Example P1, wherein the control circuitry is to not update the display panel drivers other than the subset of display panel drivers based on the partial frame update.
Example P3 includes the subject matter of Example P1 or P2, wherein the control circuitry is to cause the display panel drivers to not self-refresh based on no new frame data being received and a blanking period for the display not expiring.
Example P4 includes the subject matter of any one of Examples P1-P3, wherein the control circuitry is the cause the display panel drivers to self-refresh based on a blanking period for the display expiring.
Example P5 includes the subject matter of any one of Examples P1-P4, wherein the control circuitry is to cause a portion of the display panel drivers to not update based on device context information or usage context information.
Example P6 includes the subject matter of any one of Examples P1-P4, wherein the control circuitry is to power gate a portion of the display panel drivers based on device context information or usage context information.
Example P7 includes the subject matter of any one of Examples P1-P6, wherein the apparatus is a timing controller (TCON).
Example P8 includes the subject matter of any one of Examples P1-P6, wherein the apparatus is a display and further comprises the display panel drivers and a frame buffer, wherein the control circuitry is implemented in a timing controller (TCON) of the display.
Example P9 includes the subject matter of any one of Examples P1-P6, wherein the apparatus is a computing system comprising the graphics source and a display comprising the display panel drivers and a panel coupled to the display panel drivers.
Example P10 is a computing device comprising: a graphics source; a display coupled to the graphics source, the display comprising a panel and a plurality of drivers for respective portions of the panel; and circuitry to implement the apparatus of any one of Examples P1-P6.
Example P11 includes the subject matter of Example P10, wherein the computing device is a laptop computing device.
Example P12 includes the subject matter of Example P10, wherein the computing device comprises clamshell computing device with a flexible display.
Example P13 is a method comprising: receiving a partial frame update from a graphics source; and updating a subset of display panel drivers based on the partial frame update, the subset of display panel drivers corresponding to portions of the display to be updated by the partial frame update.
Example P14 includes the subject matter of Example P13, further comprising not updating the display panel drivers other than the subset of display panel drivers based on the partial frame update.
Example P15 includes the subject matter of Example P13 or P14, further comprising not self-refreshing the display panel drivers based on no new frame data being received and a blanking period for the display not expiring.
Example P16 includes the subject matter of any one of Examples P13-P15, further comprising self-refreshing the display panel drivers based on a blanking period for the display expiring.
Example P17 includes the subject matter of any one of Examples P13-P16, further comprising not updating a subset of the display panel drivers based on device context information or usage context information.
Example P18 includes the subject matter of any one of Examples P13-P17, further comprising power gating a subset of the display panel drivers based on device context information or usage context information.
Example P19 includes the subject matter of any one of Examples P13-P18, further comprising storing the partial frame update in a frame buffer, wherein the display panel drivers are periodically updated based on the frame buffer.
Example P20 is an apparatus comprising circuitry to implement the method of any one of Examples P13-P19, or to implement any of the other aspects described herein.
Example P21 is a display comprising the apparatus of any one of Examples P1-P6, or circuitry to implement the method of any one of Examples P13-P19, or to implement any of the other aspects described herein.
Example P22 is a computing system comprising circuitry to implement the apparatus of any one of Examples P1-P9, circuitry to implement the method of any one of Examples P13-P19, or to implement any of the other aspects described herein.
Example 1 is one or more computer-readable storage media comprising instructions that when executed by processing circuitry cause the processing circuitry to: access a partial frame update to be displayed on a display panel comprising a plurality of panel regions; determine a subset of the panel regions to refresh based on the partial frame update; and cause a subset of driver circuitries of the display panel to refresh the subset of panel regions. The computer-readable storage media may be implemented in firmware of a timing controller (TCON) of a display, or in software and/or firmware of a graphics source device.
Example 2 includes the subject matter of claim 1, wherein the instructions are to cause the subset of panel regions to be refreshed by controlling activation of a subset of driver circuitries of the display panel that correspond to the subset of regions of the display panel.
Example 3 includes the subject matter of claim 1 or 2, wherein the instructions are to not refresh other regions of the display panel while the subset of regions of the display panel are refreshed.
Example 4 includes the subject matter of any one of claims 1-3, wherein the instructions are to cause regions of the display panel to self-refresh based on a blanking period for the region expiring.
Example 5 includes the subject matter of any one of claims 1-4, wherein the instructions are to obtain context information and cause regions of the display panel other than the subset of regions to not be refreshed based on the context information.
Example 6 includes the subject matter of claim 5, wherein the instructions are to cause the regions of the display panel other than the subset of regions to be power gated based on the context information.
Example 7 includes the subject matter of claim 5 or 6, wherein the context information includes one or more of device context information indicating a usage of components of a device, usage context information indicating current user interactions with the device, or application context information indicating application functionality or execution on the device.
Example 8 includes the subject matter of any one of claims 1-7, wherein the instructions are to obtain information from the display panel indicating a number of panel regions in the display panel and transmit frame updates to the display panel based on the information.
Example 9 includes the subject matter of claim 8, wherein the instructions are to determine a frame slice to send to the display panel based on the information from the display panel indicating the number of panel regions.
Example 10 is a display comprising: a panel comprising a plurality of panel regions; a plurality of driver circuitries, each driver circuitry to control activation of a respective panel region; and control circuitry coupled to the driver circuitries, the control circuitry to: receive a partial frame update from a source; determine a subset of panel regions to refresh based on the partial frame update; and cause a subset of the driver circuitries to refresh the subset of panel regions.
Example 11 includes the subject matter of claim 10, wherein the control circuitry is to not cause the panel regions other than the subset of panel regions based on receiving the partial frame update.
Example 12 includes the subject matter of claim 10 or 11, wherein the control circuitry is to cause the panel regions to self-refresh based on a blanking period for the panel region expiring.
Example 13 includes the subject matter of any one of claims 10-12, wherein the control circuitry is further to power gate a portion of the driver circuitries.
Example 14 includes the subject matter of any one of claims 10-13, wherein the display further comprises a plurality of frame buffers, each frame buffer corresponding to a respective panel region.
Example 15 includes the subject matter of any one of claims 10-14, wherein the circuitry is within a timing controller (TCON) of the display.
Example 16 is a computing device comprising: a graphics source; a display panel coupled to the graphics source, the display panel comprising a plurality of regions independently driven by respective driver circuitries; and control circuitry to control the respective driver circuitries for each of the display panel regions, the control circuitry to: access a partial frame update; determine a subset of display panel regions to refresh based on the partial frame update; and control activation of a subset of the driver circuitries to refresh the subset of the display panel regions.
Example 17 includes the subject matter of claim 16, wherein the control circuitry is to not refresh panel regions other than the subset of panel regions based on the partial frame update.
Example 18 includes the subject matter of claim 16 or 17, wherein the circuitry is implemented in the graphics source.
Example 19 includes the subject matter of claim 16 or 17, wherein the circuitry is implemented in a timing controller (TCON) coupled to the display panel.
Example 20 includes the subject matter of any one of claims 16-19, wherein the computing device is a laptop computing device.
Example 21 is a method comprising: receiving a partial frame update to be displayed on a display panel; and refreshing a subset of regions of the display panel based on the partial frame update.
Example 22 includes the subject matter of claim 21, wherein refreshing the subset of regions comprises sending refresh signals to a subset of driver circuitries of the display panel corresponding to the subset of regions of the display panel.
Example 23 includes the subject matter of claim 21 or 22, wherein other regions of the display panel are not refreshed while the subset of regions of the display panel are refreshed.
Example 24 includes the subject matter of any one of claims 21-23, further comprising self-refreshing regions of the display panel based on a blanking period for the region expiring.
Example 25 includes the subject matter of any one of claims 21-24, further comprising obtaining context information and not refreshing regions of the display panel other than the subset of regions based on the context information.
Example 26 includes the subject matter of claim 25, wherein no refreshing regions comprises power gating the regions based on the context information.
Example 27 includes the subject matter of claim 25 or 26, wherein the context information includes one or more of device context information indicating a usage of components of a device, usage context information indicating current user interactions with the device, or application context information indicating application functionality or execution on the device.
Example 28 includes the subject matter of any one of claims 21-27, further comprising obtaining information from the display panel indicating a number of panel regions in the display panel and transmitting frame updates to the display panel based on the information.
Example 29 includes the subject matter of claim 28, further comprising determining a frame slice to send to the display panel based on the information from the display panel indicating the number of panel regions.
Example 30 is machine readable code comprising instructions to implement the method of any one of Examples 21-29.
Example 31 is an apparatus comprising means to implement the method of any one of Examples 21-29.

1. One or more computer-readable storage media comprising instructions that when executed by processing circuitry cause the processing circuitry to:
access a partial frame update to be displayed on a display panel comprising a plurality of panel regions;
determine a subset of the panel regions to refresh based on the partial frame update; and
cause a subset of driver circuitries of the display panel to refresh the subset of panel regions.

2. The computer-readable storage media of claim 1, wherein the instructions are to cause the subset of regions to be refreshed by controlling activation of a subset of driver circuitries of the display panel that correspond to the subset of regions of the display panel.

3. The computer-readable storage media of claim 1, wherein the instructions are to not refresh other regions of the display panel while the subset of regions of the display panel are refreshed.

4. The computer-readable storage media of claim 1, wherein the instructions are to cause regions of the display panel to self-refresh based on a blanking period for the region expiring.

5. The computer-readable storage media of claim 1, wherein the instructions are to obtain context information and cause regions of the display panel other than the subset of regions to not be refreshed based on the context information.

6. The computer-readable storage media of claim 5, wherein the instructions are to cause the regions of the display panel other than the subset of regions to be power gated based on the context information.

7. The computer-readable storage media of claim 5, wherein the context information includes one or more of device context information indicating a usage of components of a device, usage context information indicating current user interactions with the device, or application context information indicating application functionality or execution on the device.

8. The computer-readable storage media of claim 1, wherein the instructions are to obtain information from the display panel indicating a number of panel regions in the display panel and transmit frame updates to the display panel based on the information.

9. The computer-readable storage media of claim 8, wherein the instructions are to determine a frame slice to send to the display panel based on the information from the display panel indicating the number of panel regions.

10. A display comprising:
a panel comprising a plurality of panel regions;
a plurality of driver circuitries, each driver circuitry to control activation of a respective panel region; and
control circuitry coupled to the driver circuitries, the control circuitry to:
receive a partial frame update from a source;
determine a subset of panel regions to refresh based on the partial frame update; and
cause a subset of the driver circuitries to refresh the subset of panel regions.

11. The display of claim 10, wherein the control circuitry is to not cause the panel regions other than the subset of panel regions based on receiving the partial frame update.

12. The display of claim 10, wherein the control circuitry is to cause the panel regions to self-refresh based on a blanking period for the panel region expiring.

13. The display of claim 10, wherein the control circuitry is further to power gate a portion of the driver circuitries.

14. The display of claim 10, wherein the display further comprises a plurality of frame buffers, each frame buffer corresponding to a respective panel region.

15. The display of claim 10, wherein the control circuitry is within a timing controller (TCON) of the display.

16. A computing device comprising:
a graphics source;
a display panel coupled to the graphics source, the display panel comprising a plurality of regions independently driven by respective driver circuitries; and
control circuitry to control the respective driver circuitries for each of the display panel regions, the control circuitry to:
access a partial frame update;
determine a subset of display panel regions to refresh based on the partial frame update; and
control activation of a subset of the driver circuitries to refresh the subset of the display panel regions.

17. The computing device of claim 16, wherein the control circuitry is to not refresh panel regions other than the subset of panel regions based on the partial frame update.

18. The computing device of claim 16, wherein the control circuitry is implemented in the graphics source.

19. The computing device of claim 16, wherein the control circuitry is implemented in a timing controller (TCON) coupled to the display panel.

20. The computing device of claim 16, wherein the computing device is a laptop computing device.
